(19) United States
(12) Patent Application Publication
(10) Pub. No.: US 2026/0368208 A1
(43) Pub. Date: Nov. 19, 2026

(54) SYSTEMS AND METHODS FOR DYNAMIC CLIENT ONBOARDING

(71) Applicant: JPMORGAN CHASE BANK, N.A., New York, NY (US)

(72) Inventors: Paramveer Singh THIND, Pittsburg, CA (US); Zijian WU, Sunnyvale, CA (US); Cathy YIN, Palo Alto, CA (US); Justin LAWRENCE, Menlo Park, CA (US); Yury CHURKIN, Ottawa (CA)

(21) Appl. No.: 19/210,420

(22) Filed: May 16, 2025

(51) Int. Cl. G06F 16/28

(52) U.S. Cl. CPC G06F 16/288

(57) ABSTRACT

Systems and methods for dynamic client onboarding are disclosed. A method may include: receiving A-Attribute mapping rules for mapping client fields for a client to A-Attributes; receiving a target product with client fields for onboarding; replacing the client fields in the target product with A-Attributes using the A-Attribute mapping rules; outputting a computer file comprising a mapping of the client fields in the target product to the A-Attributes; receiving the target product and the computer file; retrieving field data for the A-Attributes in the computer file; replacing the A-Attributes in the target product with the field data; generating a payload comprising the target product with the field data; and consuming the payload.

### BACKGROUND OF THE INVENTION

### 1. Field of the Invention

Embodiments generally relate to systems and methods for dynamic client onboarding.

### 2. Description of the Related Art

Organizations with different clients often deal with different documents and different information mapping for each client. Thus, when a new client is onboarded, processes that retrieve information for the clients must be manually coded for each possible combination of client and respective product attributes.

### SUMMARY OF THE INVENTION

Systems and methods for dynamic client onboarding are disclosed. According to one embodiment, a method may include: receiving, by a dynamic mapping computer program, A-Attribute mapping rules for mapping client fields for a client to A-Attributes; receiving, by the dynamic mapping computer program, a target product with client fields for onboarding; replacing, by the dynamic mapping computer program, the client fields in the target product with A-Attributes using the A-Attribute mapping rules; outputting, by the dynamic mapping computer program, a computer file comprising a mapping of the client fields in the target product to the A-Attributes; receiving, by a gateway payload creator computer program, the target product and the computer file; retrieving, by the gateway payload creator computer program, field data for the A-Attributes in the computer file; replacing, by the gateway payload creator computer program, the A-Attributes in the target product with the field data; generating, by the gateway payload creator computer program, a payload comprising the target product with the field data; and consuming, by a payload processor, the payload.

In one embodiment, the A-Attribute mapping rules may be provided by a machine learning engine trained on historical mappings.

In one embodiment, the computer file may include a JSON file.

In one embodiment, the target product may be for the client.

In one embodiment, the method may also: receiving, by the gateway payload creator computer program, a second target product; replacing, by the gateway payload creator computer program, the A-Attributes in the second target product with the field data; generating, by the gateway payload creator computer program, a second payload comprising the second target product with the field data; and consuming, by a payload processor, the second payload.

In one embodiment, the target product may include a document.

According to another embodiment, a non-transitory computer readable storage medium may include instructions stored thereon, which when read and executed by one or more computer processors, cause the one or more computer processors to perform steps comprising: receiving A-Attribute mapping rules for mapping client fields for a client to A-Attributes; receiving a target product with client fields for onboarding; replacing the client fields in the target product with A-Attributes using the A-Attribute mapping rules; outputting a computer file comprising a mapping of the client fields in the target product to the A-Attributes; receiving the target product and the computer file; retrieving field data for the A-Attributes in the computer file; replacing the A-Attributes in the target product with the field data; generating a payload comprising the target product with the field data; and consuming the payload.

In one embodiment, the A-Attribute mapping rules may be provided by a machine learning engine trained on historical mappings.

In one embodiment, the computer file may include a JSON file.

In one embodiment, the target product may be for the client.

In one embodiment, the non-transitory computer readable storage medium may also include instructions stored thereon, which when read and executed by the one or more computer processors, cause the one or more computer processors to perform steps comprising: receiving a second target product; replacing the A-Attributes in the second target product with the field data; generating a second payload comprising the second target product with the field data; and consuming the second payload.

In one embodiment, the target product may include a document.

According to another embodiment, a system may include: a mapping rules database comprising A-Attribute mapping rules for mapping client fields for a client to A-Attributes; a field data database comprising field data for a client; and a dynamic mapping engine computer program that may be configure to receive the A-Attribute mapping rules, to receive a target product with client fields for onboarding, to replace the client fields in the target product with A-Attributes using the A-Attribute mapping rules, to output a computer file comprising a mapping of the client fields in the target product to the A-Attributes, to receive the target product and the computer file, to retrieve the field data for the A-Attributes in the computer file, to replace the A-Attributes in the target product with the field data; to generate a payload comprising the target product with the field data, and to consume the payload.

In one embodiment, the A-Attribute mapping rules may be provided by a machine learning engine trained on historical mappings.

In one embodiment, the computer file may include a JSON file.

In one embodiment, the target product may be for the client.

In one embodiment, the dynamic mapping engine computer program may be further configured to receive a second target product, to replace the A-Attributes in the second target product with the field data, to generate a second payload comprising the second target product with the field data, and to consume the second payload.

In one embodiment, the target product may include a document.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for dynamic client onboarding according to an embodiment;

FIG. 2 depicts a method for dynamic client onboarding according to an embodiment;

FIG. 3 depicts an exemplary computing system for implementing aspects of the present disclosure.

### DETAILED DESCRIPTION OF PREFERRED EMBODIMENTS

Embodiments generally relate to systems and methods for dynamic client onboarding.

As used herein, “A-Attributes” refer to a generic identifier for a field. Each client may have multiple fields, and each field may be mapped to an A-Attribute. When a document is to be populated, the value for the A-Attribute may be retrieved from a database and inserted into the document.

“Field data” may refer to actual values for the A-Attributes.

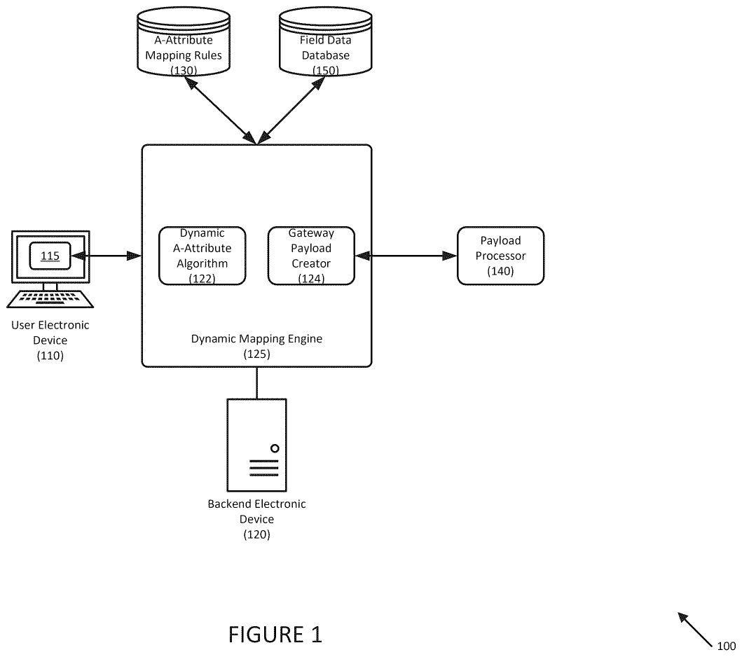

Referring to FIG. 1, a system for dynamic client onboarding is disclosed according to an embodiment. System 100 may include customer electronic device 110, which may be a computer (e.g., a workstation, desktop, laptop, notebook, etc.), a smart phone, a smart watch, an Internet of Things (IoT) appliance, etc. Customer electronic device 110 may execute computer program 115, which may be an application, a browser, etc.

Computer program 115 may interface with backend electronic device 120 such as a server (e.g., physical and/or cloud-based), a computer, etc. Backend electronic device 120 may include dynamic mapping engine 125 and gateway payload creator 124. Dynamic A-Attribute algorithm 122 may be an algorithm that is responsible for calculating A-Attribute mapped values.

Gateway payload creator 124 may be a computer program that builds the final payload to be sent to next decision-making service. The final payload is a document with the actual values for the fields included.

Dynamic mapping engine 125 may interface with A-Attribute mapping rules database 130, which may store data regarding mapping rules between client and A-Attributes for the client fields. In one embodiment, the mapping rules may be stored in one or more tables.

Field data database 150 may store values for the A-Attributes, such as names, addresses, etc.

Payload processor 140 may be a consumer of the final payload from gateway payload creator 124. After consuming the payload, payload processor 140 may issue a decision, may take an action, etc. based on the payload. Because every A-Attribute may have its own definition, the A-Attributes may be used for decisioning, for passing through information for trigger action(s), and/or for storing information.

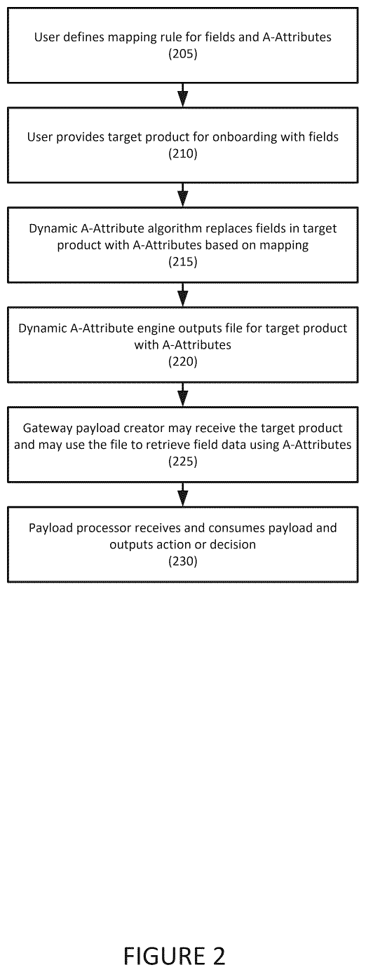

Referring to FIG. 2, a method for dynamic client onboarding is disclosed according to an embodiment.

In step 205, a computer program, such as a dynamic mapping engine, may receive mapping rules for client fields to A-Attributes from a user. For example, a user may review fields in historical documents and policies to define the mapping rules for mapping different fields used by clients to A-Attributes.

In another embodiment, a trained machine learning engine may identify the mapping for client fields to A-Attributes.

In step 210, the dynamic mapping engine may receive a target product with client fields for onboarding. For example, the target product may be a document mapping for a new entity or client.

In step 215, the dynamic mapping engine may review the target product and may replace the client fields with A-Attributes using A-Attribute mapping rules, and in step 220, the dynamic A-Attribute engine may generate and output a file for target product with the A-Attribute identifiers in the client fields. In one embodiment, the file may be a JSON file.

In one embodiment, the file may be used with other documents from the client or entity associated with the target product. For example, once the mapping for a client is established, that mapping may be used with other documents from the same client.

An example of a file output from the dynamic mapping engine is as follows:

```
{
  A00235 : John,
  A00236 : Doe,
  A00457:
    {
      A00345: 123 Main St,
      A00346: 94306,
      A00347: Palo Alto,
    ......
      }
  ....
}
```

This mapping provides a mapping of A-Attributes to real values, which is the output of the dynamic mapping engine.

In step 225, a gateway payload creator may receive the file and may use the A-Attributes to retrieve field data for the target document, or any other document from the client or entity associated with the target product. This may result a payload.

In step 230, a payload processor may receive and consume the payload. The result of the consumption may be an action, a decision, etc.

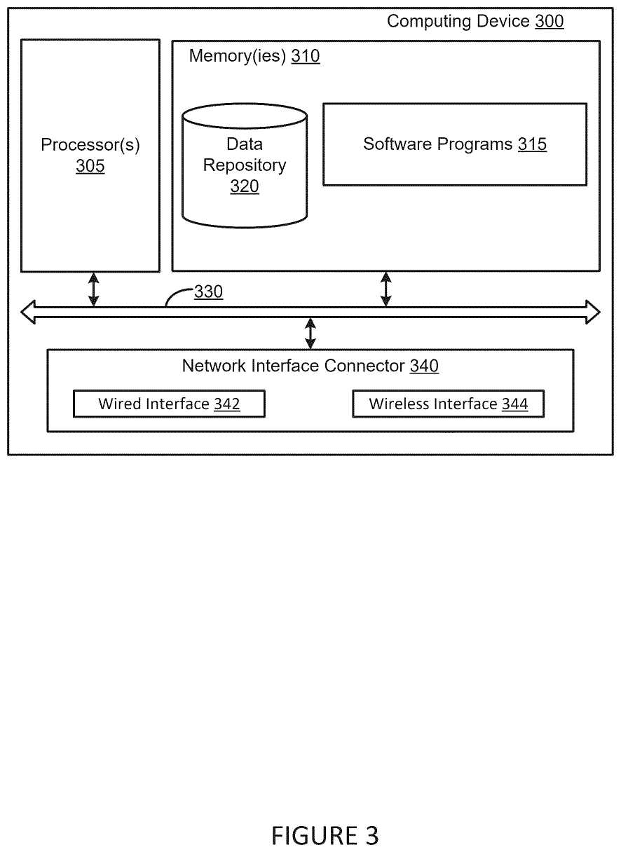

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by a dynamic mapping computer program, A-Attribute mapping rules for mapping client fields for a client to A-Attributes, wherein the A-Attributes are generic identifiers for each of the client fields;
receiving, by the dynamic mapping computer program, a target product with client fields for onboarding;
replacing, by the dynamic mapping computer program, the client fields in the target product with A-Attributes using the A-Attribute mapping rules;
outputting, by the dynamic mapping computer program, a computer file comprising a mapping of the client fields in the target product to the A-Attributes;
receiving, by a gateway payload creator computer program, the target product and the computer file;
retrieving, by the gateway payload creator computer program, field data for the A-Attributes in the computer file;
replacing, by the gateway payload creator computer program, the A-Attributes in the target product with the field data;
generating, by the gateway payload creator computer program, a payload comprising the target product with the field data; and
consuming, by a payload processor, the payload.

2. The method of claim 1, wherein the A-Attribute mapping rules are provided by a machine learning engine trained on historical mappings.

3. The method of claim 1, wherein the computer file comprises a JSON file.

4. The method of claim 1, wherein the target product is for the client.

5. The method of claim 1, further comprising:
receiving, by the gateway payload creator computer program, a second target product;
replacing, by the gateway payload creator computer program, the A-Attributes in the second target product with the field data;
generating, by the gateway payload creator computer program, a second payload comprising the second target product with the field data; and
consuming, by a payload processor, the second payload.

6. The method of claim 1, wherein the target product comprises a document.

7. A non-transitory computer readable storage medium, including instructions stored thereon, which when read and executed by one or more computer processors, cause the one or more computer processors to perform steps comprising:
receiving A-Attribute mapping rules for mapping client fields for a client to A-Attributes, wherein the A-Attributes are generic identifiers for each of the client fields;
receiving a target product with client fields for onboarding;
replacing the client fields in the target product with A-Attributes using the A-Attribute mapping rules;
outputting a computer file comprising a mapping of the client fields in the target product to the A-Attributes;
receiving the target product and the computer file;
retrieving field data for the A-Attributes in the computer file;
replacing the A-Attributes in the target product with the field data;
generating a payload comprising the target product with the field data; and
consuming the payload.

8. The non-transitory computer readable storage medium of claim 7, wherein the A-Attribute mapping rules are provided by a machine learning engine trained on historical mappings.

9. The non-transitory computer readable storage medium of claim 7, wherein the computer file comprises a JSON file.

10. The non-transitory computer readable storage medium of claim 7, wherein the target product is for the client.

11. The non-transitory computer readable storage medium of claim 7, further including instructions stored thereon, which when read and executed by the one or more computer processors, cause the one or more computer processors to perform steps comprising:
receiving a second target product;
replacing the A-Attributes in the second target product with the field data;
generating a second payload comprising the second target product with the field data; and
consuming the second payload.

12. The non-transitory computer readable storage medium of claim 7, wherein the target product comprises a document.

13. A system, comprising:
a mapping rules database comprising A-Attribute mapping rules for mapping client fields for a client to A-Attributes, wherein the A-Attributes are generic identifiers for each of the client fields;
a field data database comprising field data for a client; and
an electronic device comprising a computer processor and a memory executing a dynamic mapping engine computer program that is configure to receive the A-Attribute mapping rules, to receive a target product with client fields for onboarding, to replace the client fields in the target product with A-Attributes using the A-Attribute mapping rules, to output a computer file comprising a mapping of the client fields in the target product to the A-Attributes, to receive the target product and the computer file, to retrieve the field data for the A-Attributes in the computer file, to replace the A-Attributes in the target product with the field data; to generate a payload comprising the target product with the field data, and to consume the payload.

14. The system of claim 13, wherein the A-Attribute mapping rules are provided by a machine learning engine trained on historical mappings.

15. The system of claim 13, wherein the computer file comprises a JSON file.

16. The system of claim 13, wherein the target product is for the client.

17. The system of claim 13, wherein the dynamic mapping engine computer program is further configured to receive a second target product, to replace the A-Attributes in the second target product with the field data, to generate a second payload comprising the second target product with the field data, and to consume the second payload.

18. The system of claim 13, wherein the target product comprises a document.
